(19) United States
(12) Patent Application Publication
(10) Pub. No.: US 2017/0239916 A1
(43) Pub. Date: Aug. 24, 2017

(54) COMPOSITES FORMED FROM CO-CURE ADHESIVE

(71) Applicants: Scott M. Lewit, Indialantic, FL (US); Ronnal P. Reichard, Melbourne, FL (US); Travis S. McCloud, Cadiz, KY (US)

(72) Inventors: Scott M. Lewit, Indialantic, FL (US); Ronnal P. Reichard, Melbourne, FL (US); Travis S. McCloud, Cadiz, KY (US)

(21) Appl. No.: 15/439,789

(22) Filed: Feb. 22, 2017

Related U.S. Application Data
(60) Provisional application No. 62/299,215, filed on Feb. 24, 2016.
(60) Provisional application No. 62/357,045, filed on Jun. 30, 2016.

(51) Int. Cl. B32B 7/12; B32B 38/00; B32B 37/12; B32B 15/08; B32B 27/20

(52) U.S. Cl. CPC B32B 7/12; B32B 15/08; B32B 27/20; B32B 37/12; B32B 38/0012; B32B 2605/00

(57) ABSTRACT

A composite structure, such as a composite floor structure, and method of making the same are disclosed. The composite structure includes a fiber-reinforced plastic; a metal; and a co-cure adhesive bonding the fiber-reinforced plastic and metal, wherein the adhesive comprises at least one resin selected from a vinyl ester resin, a polyester resin, and an epoxy resin and at least one elastomer. Some or all of these components may be integrally molded together to form a fiber-reinforced polymer structure. The composite floor structure may be used for cargo vehicles and other applications.

### CROSS REFERENCE TO RELATED APPLICATIONS

The present application claims priority to U.S. Provisional Application Nos. 62/299,215, filed Feb. 24, 2016, and 62/357,045, filed Jun. 30, 2016, the entire disclosures of which are hereby incorporated by reference in their entirety.

### FIELD OF THE DISCLOSURE

The present disclosure relates generally to composites formed from co-cure adhesive materials and methods of making the same. More particularly, the present disclosure relates to composites of metal and laminate composites such as fiber-reinforced plastics (FRP) useful in cargo vehicles and other applications, and to methods of making the same.

### BACKGROUND OF THE DISCLOSURE

Cargo vehicles are used in the transportation industry for transporting many different types of cargo. Certain cargo vehicles may be refrigerated and insulated to transport temperature-sensitive cargo. Cargo vehicles may be constructed using composite materials, which may lead to an absence of or reduction in metallic and wood materials and associated advantages, including simplified construction, thermal efficiency, reduced water intrusion and corrosion, and improved fuel efficiency through weight reduction, for example.

### SUMMARY OF THE DISCLOSURE

A composite structure, such as a composite floor structure, and methods of making the same are provided. The composite structure includes a fiber-reinforced plastic, a metal, and a co-cure adhesive bonding the fiber-reinforced plastic and metal. Some or all of these components may be integrally molded together to form a fiber-reinforced polymer structure. The composite floor structure may be used for cargo vehicles and other applications.

According to an exemplary embodiment of the present disclosure, a composite structure is provided. The composite structure includes a fiber-reinforced plastic; a metal; and a co-cure adhesive bonding the fiber-reinforced plastic and metal. The adhesive comprises at least one resin selected from a vinyl ester resin, a polyester resin, and an epoxy resin and at least one elastomer. In a more particular embodiment, the fiber-reinforced plastic is a laminate structure. In another more particular embodiment, the composite structure is a composite floor structure for a cargo vehicle. In still another more particular embodiment, the fiber-reinforced plastic comprises a fiber-wrapped foam core. In yet still another more particular embodiment, the fiber-reinforced plastic comprises a composite preform. In a more particular embodiment, the elastomer is urethane. In an even more particular embodiment, the elastomer comprises from 5 wt. % to 95 wt. %, of the total weight of the co-cure adhesive, such as from 10 wt. % to 25 wt. % or from 50 wt. % to 95 wt. %.

According to another exemplary embodiment, a composite floor structure is provided. The floor structure includes a platform having an upper metal surface, a plurality of fabric-reinforced plastic layers; and a co-cure adhesive bonding the metal surface and at least one of the fiber-reinforced plastic layers, wherein the adhesive comprises at least one resin selected from a vinyl ester resin, a polyester resin, and an epoxy resin and at least one elastomer. In a more particular embodiment, the floor structure further comprises a plurality of transverse beams integrally molded to the platform. In a more particular embodiment, each transverse beam includes: a preform; a first reinforcing layer sized to wrap around the preform; and a second reinforcing layer sized smaller than the first reinforcing layer for selection positioning beneath the preform.

According to another exemplary embodiment, a method of bonding a fiber-reinforced plastic to a metal is provided. The method includes applying an adhesive to a surface of the metal to form a co-cure layer wherein the adhesive is a co-cure adhesive comprising at least one resin selected from a vinyl ester resin, a polyester resin, and an epoxy resin and at least one elastomer; contacting the co-cure layer with a reinforcing layer and a reinforcement resin; and curing the resin to form a fiber-reinforced plastic, wherein the fiber-reinforced plastic is bonded to the metal by the co-cure layer. In one more particular embodiment, the adhesive is at least partially cured prior to application of the reinforcing layer. In another more particular embodiment, curing the reinforcement resin further comprises curing the co-cure adhesive of the co-cure layer. In still another more particular embodiment, the reinforcement resin is a co-cure adhesive comprising at least one resin selected from a vinyl ester resin, a polyester resin, and an epoxy resin and at least one elastomer, and wherein curing the reinforcement resin further comprises curing the co-cure adhesive of the co-cure layer. In a more particular embodiment of any of the above embodiments, the method also includes pretreating the surface of the metal prior to applying the adhesive, such as by applying an organic solvent and/or roughening the surface of the metal. In a more particular embodiment of any of the above embodiments, the reinforcement resin is a co-cure adhesive resin. In a more particular embodiment of any of the above embodiments, the surface of the metal forms a portion of a mold into which the reinforcing layer and reinforcement resin are applied. In a more particular embodiment of any of the above embodiments, contacting the co-cure layer with a reinforcing layer and a reinforcement resin further includes contacting the co-cure layer with a catalyst. In a more particular embodiment of any of the above embodiments the method further includes coating a second surface of the metal with a co-cure adhesive resin comprising at least one resin selected from a vinyl ester resin, a polyester resin, and an epoxy resin and at least one elastomer, wherein the second surface is opposite the surface to which the adhesive is applied. In a still more particular embodiment, the coating step is performed prior to the contacting step. In another more particular embodiment, the coating step is performed after the contacting step. In a more particular embodiment of any of the above embodiments, the method further includes forming the metal, the fiber-reinforced plastic, and the cured co-cure layer into a desired shape by applying a force to deform the metal.

Additional features and advantages of the present invention will become apparent to those skilled in the art upon consideration of the following detailed description of the illustrative embodiments exemplifying the best mode of carrying out the invention as presently perceived.

### BRIEF DESCRIPTION OF THE DRAWINGS

The foregoing aspects and many of the intended advantages of this invention will become more readily appreciated as the same becomes better understood by reference to the following detailed description when taken in conjunction with the accompanying drawings.

FIG. 1 is a top perspective view of an exemplary composite floor structure of the present disclosure, the composite floor structure including a platform, a plurality of transverse beams, and a plurality of longitudinal beams;

FIG. 2 is a rear end elevational view of the composite floor structure of FIG. 1;

FIG. 3 is a left side elevational view of the composite floor structure of FIG. 1;

FIG. 4 is a bottom plan view of the composite floor structure of FIG. 1;

FIG. 5 is an exploded perspective view of the platform of FIG. 1;

FIG. 6A is a sectional view of an exemplary embodiment of the platform of FIG. 1;

FIG. 6B is a sectional view of another exemplary embodiment of the platform of FIG. 1;

FIG. 7 is an exploded perspective view of the transverse beam of FIG. 1;

FIG. 8 is an exploded perspective view of the longitudinal beam of FIG. 1;

FIG. 9 is a sectional view of another exemplary hybrid laminated metal fiber-reinforced composite;

FIG. 10 is a sectional view of still another exemplary hybrid laminated metal fiber-reinforced composite;

FIG. 11 illustrates an exemplary molding process for forming the platform of FIG. 1;

FIG. 12A is related to the Examples and shows samples of Example 1 and Comparative Example C following static testing;

FIG. 12B is related to the Examples and shows samples of Example 1 and Comparative Example C following static testing;

FIG. 12C is related to the Examples and shows an enlarged view of the samples of FIG. 12B following static testing;

FIG. 13 is related to the Examples and shows delamination of a composite including Comparative Example C following three-point bend testing;

FIG. 14 is related to the Examples and shows no delamination of a composite including Example 1 following three-point bend testing;

FIG. 15 is related to the Examples and illustrates an elevated perspective view of a five-beam sample; and

FIG. 16 is related to the Examples and illustrates a side view of the five-beam sample of FIG. 15.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

For the purposes of promoting an understanding of the principals of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrative devices and described methods and further applications of the principles of the invention which would normally occur to one skilled in the art to which the invention relates.

A composite is disclosed. In one exemplary embodiment, the composite includes a metal surface, a fabric-reinforced plastic, and a co-cure adhesive. In some embodiments, the composite may be a hybrid laminated metal fiber-reinforced composite.

### 1. Co-Cure Adhesive

In one exemplary embodiment, a composite including a co-cure adhesive is provided. In an illustrative embodiment, the co-cure adhesive comprises one or more elastomer components, such as urethane, co-cured with one or more resin components, such as a vinyl ester, epoxy, or unsaturated polyester components. Exemplary co-cure adhesives are provided in U.S. Pat. No. 9,371,468 and U.S. Publication No. 2016/0263873, the disclosures of which are hereby incorporated by reference in their entirety.

As used herein, co-cured refers to the reactions involved in curing the urethane polymer take place essentially concurrently with the reactions involved in curing the one or more resin components, such as vinyl ester, epoxy, or unsaturated polyester component. Co-cured products are distinguishable from interpenetrating networks (IPN), at least in that co-cured products can have some reactions between the chains of the polymerized urethane component and the one or more resin components, such as cured vinyl ester, epoxy, or unsaturated polyester component.

In one exemplary embodiment, the urethane component is formed from urethane reactants, such as polyisocyanates, isocyanate-terminated prepolymers, polyols, and chain extenders. Exemplary polyisocyanates include aromatic polyisocyanates such toluene diisocyanates (TDI), 4,4′-diphenylmethane diisocyanates (MDI), and polymeric diisocyanates (PMDI), and aliphatic polyisocyanates such as hexamethylene diisocyanate (HDI), hydrogenated MDI, cyclohexane diisocyanate (CHDI), isophorone diisocyanate (IPDI), trimethyl and tetramethylhexamethylene diisocyanate (TMXDI). Exemplary isocyanate-terminated prepolymers are formed from a polyisocyanate and a polyol. Exemplary polyols have a molecular weight from 500 to 10,000 Dalton and include two to six functional groups, such as hydroxyl or amine-terminated polyether or polyester polyols, or more particularly a polyether or polyester diol or triol. Other exemplary polyols include alkoxylated sucrose polyols. Exemplary chain extenders include low-molecular-weight diols or diamines such as ethylene glycol, diethylene glycol, 1,4-butanediol, 1,6-hexanediol, ethylene diamine, 4,4′-methylene-bis(2-chloroaniline) (“MOCA”). Exemplary urethane systems include one and two components systems. Exemplary urethane systems also include pure urethane systems, i.e. systems including hydroxyl-terminated reactants only, polyurea systems, i.e. amine-terminated polyols and/or amine extenders, as well as combinations and mixtures thereof. Exemplary commercially available urethane components include a two-component polyurethane based on an aliphatic polyisocyanate available from BASF under the trade name Selby™ N300 CR and combinations of the same with polyureas such as EnviroLastic® resin available from Sherwin-Williams or Line-X® resin available from Line-X, Inc.

Exemplary polyester and vinyl esters are produced by combining an unsaturated polyester resin or vinyl ester resin with an ethylenic monomer, usually styrene, and a free-radical initiator. Exemplary unsaturated polyester resins include polymers of intermediate molecular weight made by condensing glycols, maleic anhydride, and dicarboxylic acids or their anhydrides to produce a resin. Exemplary glycols include ethylene glycol, propylene glycol, diethylene glycol, dipropylene glycol, alkoxylated bisphenol A, cyclohexane dimethanol, and neopentyl glycol. Maleic anhydride provides a crosslinkable carbon-carbon double bond capable of reacting with the ethylenic monomer in the presence of the free-radical initiator. Exemplary dicarboxylic acids and anhydrides include phthalic anhydride, isophthalic acid (which produces an isophthalic polyester resin), terephthalic acid, adipic acid, succinic acid, tetrabromophthalic anhydride, tetrahydrophthalic anhydride, maleic acid, fumaric acid, and the like.

Exemplary ethylenic monomers include, for example styrene, α-methylstyrene, divinylbenzene, methyl methacrylate, butyl acrylate, and vinyl toluene. In one exemplary embodiment, the ethylenic monomer is styrene.

Exemplary vinyl esters are formed from a reaction of an epoxy resin and an unsaturated carboxylic acid such as acrylic acid or methacrylic acid. In one exemplary embodiment, the epoxy resin is a product of bisphenol A with epichlorohydrin, further reacted with methacrylic acid to convert the epoxide end groups to vinyl ester groups.

Exemplary epoxies are formed from a reaction of an epoxy resin, such as a diglycidyl ether reaction product of bisphenol A with epichlorohydrin, with a curing agent such as an aromatic diamine. Exemplary curing agents for epoxy resins include aliphatic amines, cycloaliphatic amines, aromatic amines, polyamides, amidoamines, polysulfides, and anhydrides. In one exemplary embodiment, the resin components include an epoxy and an unsaturated polyester resin, such as isophthalic polyester resin, in combination.

In one exemplary embodiment, the co-cure adhesive includes as little as 5 wt. %, 10 wt. %, 15 wt. %, 20 wt. %, 25 wt. %, 30 wt. %, as great as 40 wt. %, 50 wt. %, 60 wt. %, 70 wt. %, 80 wt. %, 90 wt. %, or 95 wt. % of the urethane component based on the total weight of the co-cure adhesive, or within any range defined between any two of the foregoing values, such as 5 wt. % to 95 wt. %, 10 wt. % to 25 wt. %, 15 wt. % to 25 wt. %, or 50 wt. % to 95 wt. %. In one embodiment, the co-cure adhesive includes from 10 wt. % to 30 wt. % urethane, more specifically from 15 wt. % to 25 wt. % urethane.

In one exemplary embodiment, the co-cure adhesive includes as little as 5 wt. %, 10 wt. %, 20 wt. %, 30 wt. %, 40 wt. %, 50 wt. %, as great as 60 wt. %, 70 wt. %, 75 wt. %, 80 wt. %, 85 wt. %, 90 wt. %, or 95 wt. % of the one or more resin components, such as vinyl ester, epoxy, or unsaturated polyester component, based on the total weight of the co-cure adhesive, or within any range defined between any two of the foregoing values, such as 5 wt. % to 95 wt. %, 75 wt. % to 90 wt. %, or 5 wt. % to 50 wt. %.

Without wishing to be held to any particular theory, it is believed that increasing the percentage of urethane component increases the flexibility of the cured adhesive. Accordingly, in an embodiment directed to a relatively rigid composite, the co-cure adhesive may include a relatively lower amount of urethane, such as 5 wt. % to 50 wt. % or 10 wt. % to 25 wt. %, based on the total weight of the co-cure adhesive. Similarly, in an embodiment directed to a relatively flexible composite, or to an embodiment including a metal to composite interface capable of withstanding relatively large deformations, shocks, or blast loads, the co-cure adhesive may include a relatively higher amount of urethane, such as 30 wt. % to 95 wt. %, 50 wt. % to 95 wt. %, or 70 wt. % to 90 wt. %, based on the total weight of the co-cure adhesive.

### 2. Floor Structure

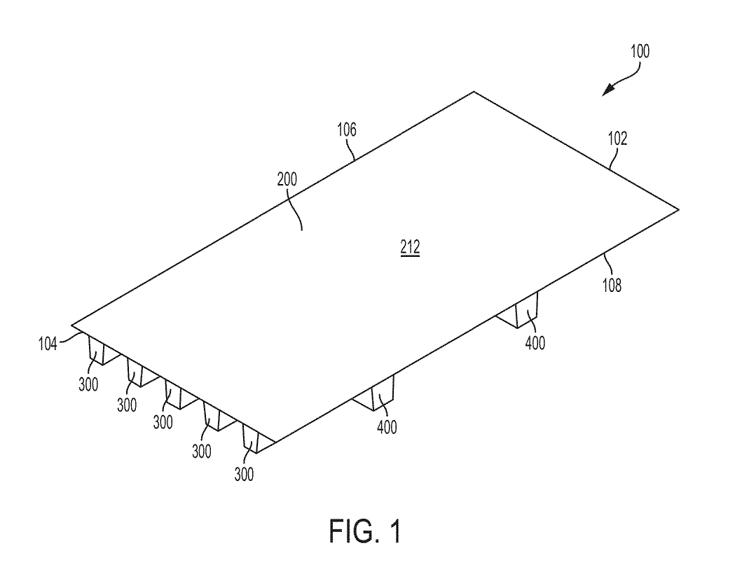

Referring initially to FIGS. 1-4, a composite floor structure 100 is shown. In certain embodiments, the composite floor structure 100 may be used in cargo vehicles for supporting and transporting cargo, including semi trailers (e.g., refrigerated semi trailers, dry freight semi trailers, flatbed semi trailers), other trailers, box trucks or vans, and the like. In other embodiments, the composite floor structure 100 may be used to construct dump trucks or dump trailers, boat docks, mezzanines, storage units, temporary shelters, military platforms, air and space vehicles, automobiles, bridge decks, or buildings, for example. In other embodiments, the composite structure 100 may a used to construct blast panels, ballistic panels, for use in viscoelastic damping, impact walls, or crash worthiness systems. Accordingly, those skilled in the art will appreciate that the present invention may be implemented in a number of different applications and embodiments and is not specifically limited in its application to the particular embodiments depicted herein.

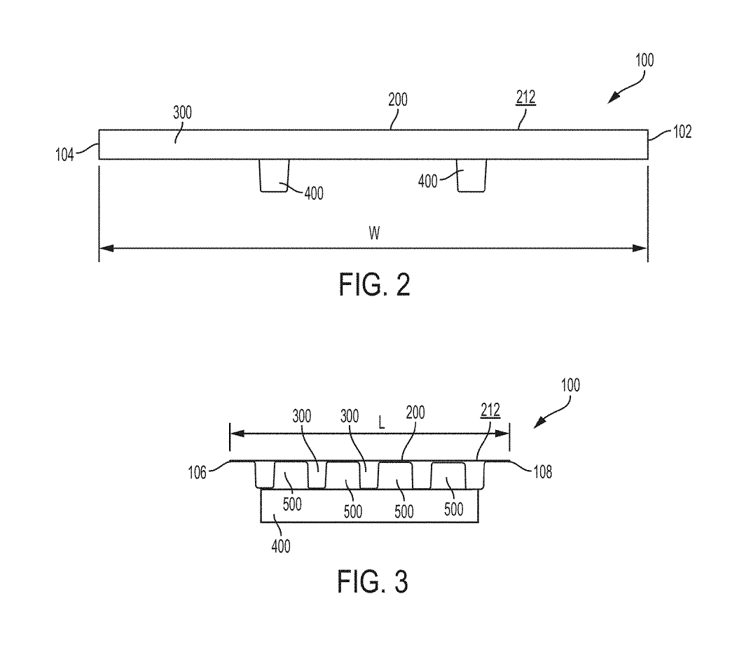

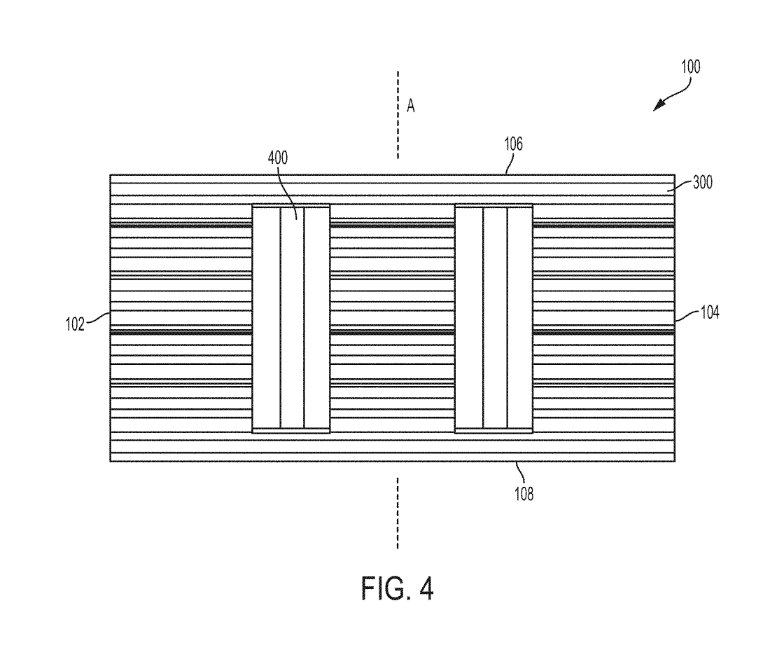

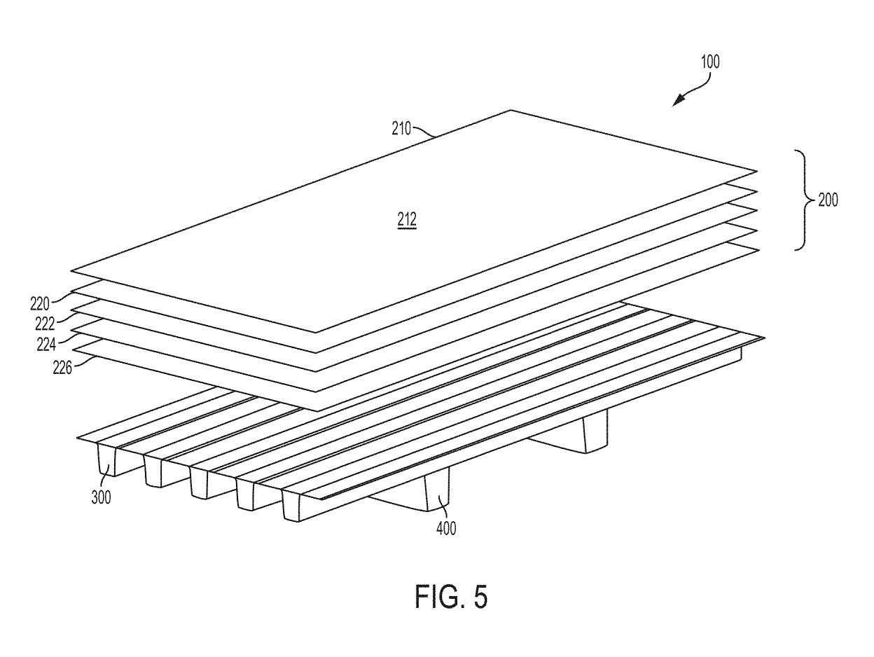

The illustrative composite floor structure 100 is generally rectangular in shape, although this shape may vary. As shown in FIG. 2, the composite floor structure 100 has a width W between a right side 102 and a left side 104. As shown in FIG. 3, the composite floor structure 100 has a length L between a front end 106 and a rear end 108. The length L and the width W may vary depending on the needs of the particular application. As shown in FIG. 4, the composite floor structure 100 also has a longitudinal axis A that extends through the front end 106 and the rear end 108.

The illustrative composite floor structure 100 includes a deck or platform 200, a plurality of transverse beams 300 extending from the right side 102 to the left side 104 beneath the platform 200, and a plurality of longitudinal beams 400 extending from the front end 106 to the rear end 108 beneath the transverse beams 300. As shown in FIG. 4, the transverse beams 300 extend perpendicular to the longitudinal axis A, and the longitudinal beams 400 extend parallel to the longitudinal axis A. As shown in FIG. 3, the composite floor structure 100 may also include insert beams 500 extending between adjacent transverse beams 300.

In the illustrated embodiment of FIGS. 1-4, the composite floor structure 100 includes five transverse beams 300 and two longitudinal beams 400, but the number of beams 300, 400 may vary depending on the needs of the particular application. Also, the size of each beam 300, 400 and the spacing between adjacent beams 300, 400 may vary depending on the needs of the particular application. For example, a relatively large number of closely-spaced beams 300, 400 may be used for high-weight/high-strength applications, whereas a relatively small number of spaced-apart beams 300, 400 may be used for low-weight/low-strength applications.

3. Composite Materials with Reinforcing Layers and/or Structural Preforms

The composite floor structure 100 may be constructed, at least in part, of composite materials. For example, the platform 200, the transverse beams 300, the longitudinal beams 400, and/or the insert beams 500 of the composite floor structure 100 may be constructed of composite materials. As such, the platform 200, the transverse beams 300, the longitudinal beams 400, and/or the insert beams 500 of the composite floor structure 100 may be referred to herein as composite structures. These composite structures may lack internal metal components. Also, each composite structure may be a single, unitary component, which may be formed from a plurality of layers permanently coupled together. Exemplary composite materials for use in the composite floor structure 100 include fiber-reinforced plastics (FRP), for example carbon-fiber-reinforced plastics (CRP).

Each composite structure may contain one or more reinforcing layers that contains reinforcing fibers and is capable of being impregnated and/or coated with a reinforcement resin, as discussed in Section 8 below. Suitable fibers include carbon fibers, glass fibers, cellulose, or polymers, for example. The fibers may present in fabric form, which may be matt, woven, non-woven, or chopped, for example. Exemplary reinforcing layers include chopped fiber fabrics, such as chopped strand mats (CSM), and continuous fiber fabrics, such as 0°/90° fiberglass fabrics, +45°/−45° fiberglass fabrics, +60°/−60° fiberglass fabrics, 0° warp unidirectional fiberglass fabrics, and other stitched fiber fabrics, for example. Such fabrics are commercially available from Vectorply Corporation of Phenix City, Ala.

According to an exemplary embodiment of the present disclosure, a plurality of different reinforcing materials may be stacked together and used in combination. For example, a chopped fiber fabric (e.g., CSM) may be positioned adjacent to a continuous fiber fabric. In this stacked arrangement, the chopped fibers may help support and maintain the adjacent continuous fibers in place, especially around corners or other transitions. Also, the chopped fibers may serve as a web to resist column-type loads in compression, while the adjacent continuous fibers may resist flange-type loads in compression. Adjacent reinforcing layers may be stitched or otherwise coupled together to simplify manufacturing, to ensure proper placement, and to prevent shifting and/or bunching.

Also, certain composite structures may contain a structural support or preform. The preform may have a structural core that has been covered with an outer fabric layer or skin. The core may be extruded, pultruded, or otherwise formed into a desired shape and cut to a desired length. In an exemplary embodiment, the core is a polyurethane foam material or another foam material, and the outer skin is a spun bond polyester material. Exemplary preforms include PRISMA® preforms provided by Compsys, Inc. of Melbourne, Fla. Advantageously, in addition to its structural effect, the foam core may have an insulating effect in certain applications, including refrigerated trucking applications. Both the core and the outer skin may be selected to accommodate the needs of the particular application. For example, in areas of the preform requiring more strength and/or insulation, a low-density foam may be replaced with a high-density foam or a hard plastic block.

Each fiber reinforcing layer 220, 222, 224, 226 illustratively includes a resin material. In one exemplary embodiment, one or more of fiber reinforcing layers 220, 222, 224, 226 includes co-cure adhesive resin as described above. In another exemplary embodiment one or more of fiber reinforcing layers 220, 222, 224, 226 includes a typical resin.

### 4. Platform

Referring next to FIG. 5, the platform 200 may be constructed from a plurality of layers permanently coupled or laminated together. From top to bottom in FIG. 5, the illustrative platform 200 includes a top layer 210 and four reinforcing layers 220, 222, 224, 226, although the number, types, and locations of these layers may vary depending on the needs of the particular application.

The top layer 210 of the platform 200 defines a generally flat upper surface 212 for supporting cargo or other objects. The upper surface 212 may be completely flat or textured (e.g., dimpled or ridged) to provide a slip-resistant surface. The top layer 210 may also define channels (i.e., ducts), and such channels may extend through the interior of top layer 210 or across a surface (e.g., upper surface 212) of top layer 210. According to an exemplary embodiment of the present disclosure, the top layer 210 is a metal (e.g., aluminum, stainless steel) layer or includes a metal upper surface 212. The top layer 210 may be extruded or otherwise formed into a desired width and cut to a desired length. The top layer 210 is bonded to the first reinforcing layer 220 using one or more co-cure adhesives as described in Section 1 above.

To accommodate different loads on the platform 200, each reinforcing layer 220, 222, 224, 226 may be unique to provide a combination of different fiber types, sizes, and/or orientations across the platform 200. Additional disclosure regarding the reinforcing layers 220, 222, 224, 226 is set forth in Section 3 above.

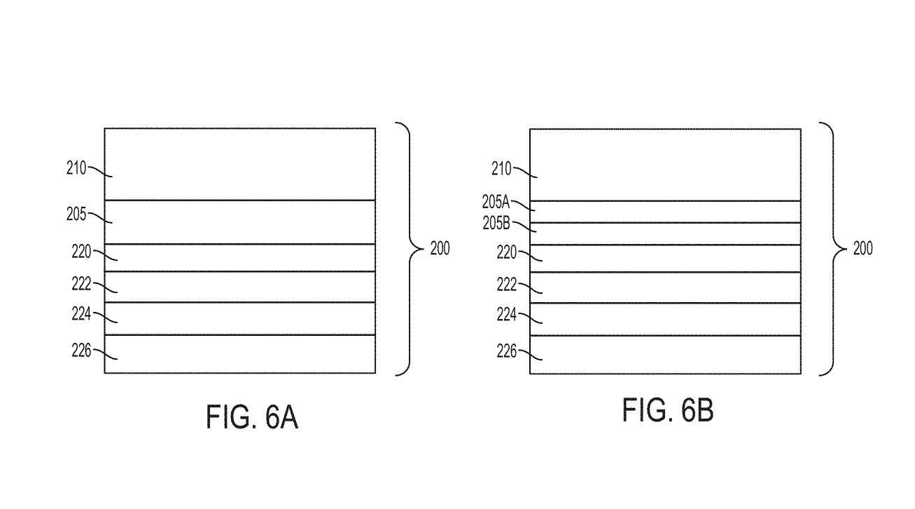

Referring next to FIG. 6A, a sectional view of an exemplary embodiment of the platform 200 is shown. The top layer 210 is illustratively a metal layer bonded to the top reinforcing layer 220 by a layer of co-cure adhesive 205. The co-cure adhesive 205 is illustratively a co-cure adhesive including one or more elastomer components, such as urethane, co-cured with one or more resin components, such as a vinyl ester, epoxy, or unsaturated polyester components, as described in Section 1 above. In some exemplary embodiments, the co-cure adhesive may be fiber-reinforced.

Referring next to FIG. 6B, a sectional view of another exemplary embodiment of the platform 200 is shown. The top layer 210 is illustratively a metal layer bonded to the top reinforcing layer 220 by two layers of co-cure adhesive 205A, 205B, although the number and types these layers may vary depending on the needs of the particular application. In one exemplary embodiment, the upper layer 205A and lower layer 205B of co-cure adhesive have different formulations and different stiffness. In a more particular embodiment, the upper layer 205A is formulated to be more rigid than lower layer 205B, such as by including less urethane content in the upper layer 205A than the lower layer 205B. Without wishing to be held to any particular theory, it is believed that including multiple layers 205A, 205B of co-cure adhesive having increasing urethane content in the direction from the metal top layer 210 to the reinforcing layers 220, 222, 224, 226, results in a more gradual transition in stiffness for the platform 200, providing better toughness, survivability, energy absorption ability, and durability for the composite. In one exemplary embodiment, each layer 205A, 205B of co-cure adhesive is separately applied and cured. In another exemplary embodiment, the first layer 205A is applied to the metal layer 210 and cured prior to application and cure of the second layer 205B.

### 5. Transverse Beams

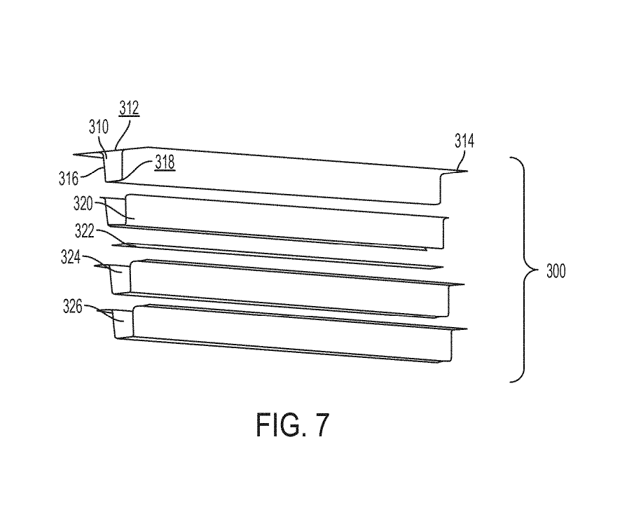

Referring next to FIG. 7, each transverse beam 300 may be constructed from a plurality of layers permanently coupled or laminated together. The transverse beams 300 may provide stiffness and resistance to bending and deflection in the transverse direction. From top to bottom in FIG. 6, the illustrative transverse beam 300 includes a preform 310 and four reinforcing layers 320, 322, 324, 326, although the number, types, and locations of these layers may vary depending on the needs of the particular application.

The illustrative preform 310 of FIG. 7 has an upper surface 312 with two flanges 314 configured to support the platform 200, side walls 316, and a lower surface 318 configured to support the longitudinal beams 400.

As shown in FIG. 7, three of the reinforcing layers 320, 324, 326 are sized and shaped to wrap around the side walls 316 and the lower surface 318 of the preform 310, whereas the reinforcing layer 322 is a thin strip that is sized for selective receipt beneath the lower surface 318 of the preform 310. To accommodate different loads on the transverse beams 300, each reinforcing layer 320, 322, 324, 326 may be unique to provide a combination of different fiber types, sizes, and/or orientations across the beam 300. Additional disclosure regarding the reinforcing layers 320, 322, 324, 326 is set forth in Section 3 above.

### 6. Longitudinal Beams

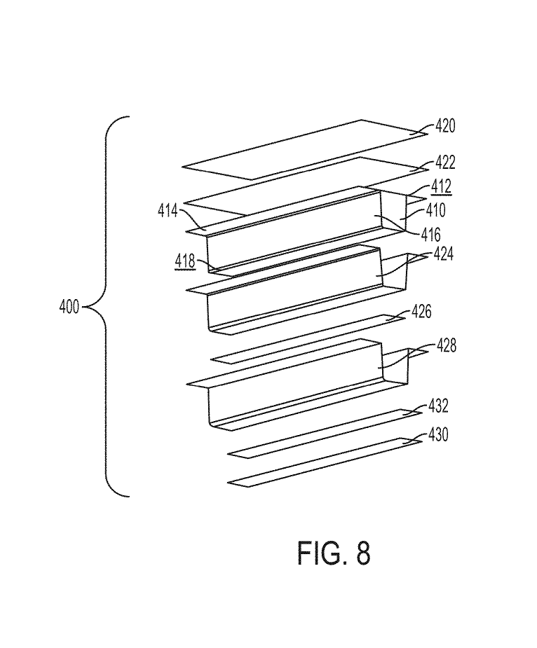

Referring next to FIG. 8, each longitudinal beam 400 may be constructed from a plurality of layers permanently coupled or laminated together. The longitudinal beams 400 may provide stiffness and resistance to bending and deflection in the longitudinal direction and may help couple adjacent transverse beams 300 together. Also, the longitudinal beams 400 may serve as a connection point for another structure, such as a vehicle chassis, a wheel assembly, or a landing gear in trucking applications. From top to bottom in FIG. 8, the illustrative longitudinal beam 400 includes two upper reinforcing layers 420, 422, a preform 410, and three lower reinforcing layers 424, 426, 428, although the number, types, and locations of these layers may vary depending on the needs of the particular application.

The illustrative preform 410 of FIG. 8 has an upper surface 412 with two flanges 414 configured to support the transverse beams 300 located above longitudinal beams 400, side walls 416, and a lower surface 418. Additional disclosure regarding the preform 410 is set forth in Section 3 above.

As shown in FIG. 8, the upper reinforcing layers 420, 422 are sized and shaped to extend across the upper surface 412 and flanges 414 of the preform 410. Two of the lower reinforcing layers 424, 428 are sized and shaped to wrap around the side walls 416 and the lower surface 418 of the preform 410, whereas the reinforcing layer 426 is a thin strip that is sized and shaped for selective receipt beneath the lower surface 418 of the preform 410. To accommodate different loads on the longitudinal beams 400, each reinforcing layer 420, 422, 424, 426, 428 may be unique to provide a combination of different fiber types, sizes, and/or orientations across the longitudinal beam 400. Additional disclosure regarding the reinforcing layers 420, 422, 424, 426, 428 is set forth above.

In one exemplary embodiment, the longitudinal beam 400 includes a metal piece, such as aluminum 430 bonded to a reinforcing layer 424, 428 by a co-cure adhesive 432 as described above. In the illustrative embodiment shown in FIG. 8, an aluminum strip 430 is bonded by co-cure adhesive 432 to an outside of outer reinforcing layer 428.

In other embodiments, the longitudinal beam 400 may be a non-composite structure, such as a metal (e.g., aluminum) beam or wood beam, for example. In these embodiments, the longitudinal beam 400 may be coupled to the rest of the composite floor structure 100 using structural adhesive and/or mechanical fasteners (e.g., bolts, rivets), for example.

### 7. Additional Hybrid Laminated Metal Fiber-Reinforced Composites

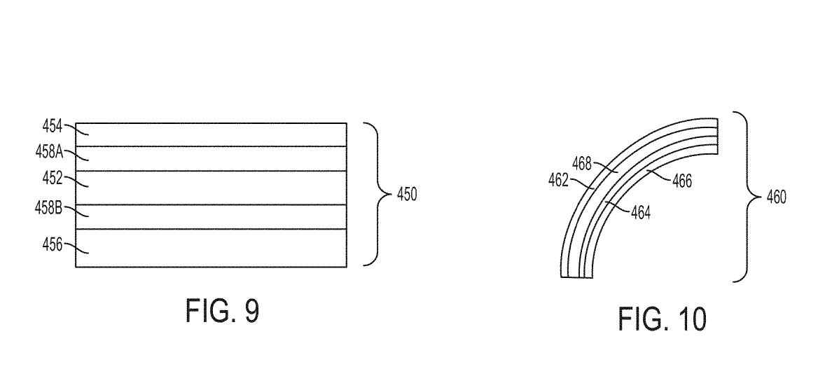

Referring next to FIG. 9, another exemplary hybrid laminated metal fiber-reinforced composite 450 is illustrated. Composite 450 illustratively includes at least one metal layer 452 and multiple reinforcing layers 454, 456, although the number, types, and locations of these layers may vary depending on the needs of the particular application. In some embodiments, the reinforcing layers 454, 456 contains reinforcing fibers and is capable of being impregnated and/or coated with a reinforcement resin, similar to the reinforcing layers 420, 422, 424, 426, 428 as described above in Section 3. In one exemplary embodiment, one or more of fiber reinforcing layers 454, 456 includes co-cure adhesive resin as described in Section 1 above. In another exemplary embodiment one or more of fiber reinforcing layers 454, 456 includes a typical resin. As illustrated in FIG. 9, each side of metal layer 452 is bonded to an adjacent reinforcing layer 454, 456 by a co-cure adhesive layer 458A, 458B. The co-cure adhesive layers 458A, 458B are each illustratively a co-cure adhesive including one or more elastomer components, such as urethane, co-cured with one or more resin components, such as a vinyl ester, epoxy, or unsaturated polyester components, as described in Section 1 above. In some exemplary embodiments, the one or more of co-cure adhesive layers 458A, 458B may be fiber-reinforced.

Referring next to FIG. 10, still another exemplary hybrid laminated metal fiber-reinforced composite 460 is illustrated. Composite 460 illustratively includes at least one metal layer 462 and one or more fiber reinforcing layers 464, 466 although the number, types, and locations of these layers may vary depending on the needs of the particular application. In another exemplary embodiment, the metal layer 462 may be positioned between two fiber reinforcing layers similar to FIG. 9. In some embodiments, one or more of the fiber reinforcing layers 464, 466 contains reinforcing fibers and is capable of being impregnated and/or coated with a reinforcement resin, similar to the reinforcing layers 420, 422, 424, 426, 428 as described above in Section 3. In one exemplary embodiment, one or more of the fiber reinforcing layers 464, 466 includes co-cure adhesive resin as described in Section 1 above. In another exemplary embodiment one or more of the fiber reinforcing layers 464, 466 includes a typical resin. At least one side of metal layer 462 is bonded to an adjacent reinforcing layer 464 by a co-cure adhesive layer 468. The co-cure adhesive layer 468 is illustratively a co-cure adhesive including one or more elastomer components, such as urethane, co-cured with one or more resin components, such as a vinyl ester, epoxy, or unsaturated polyester components, as described in Section 1 above. In some exemplary embodiments, the co-cure adhesive 466 may be fiber-reinforced.

As illustrated in FIG. 10, the composite 460 has a curved profile. In one exemplary embodiment, the metal layer 462 is formed into the desired shape prior to application of the co-cure adhesive layer 468 and/or reinforcing layers 464, 466. In another exemplary embodiment, the reinforcing layers 464, 466 are bonded to the metal layer 462 by co-cure adhesive layer 468, and then the resulting composite 460 is formed into the desired shape.

### 8. Molding Process

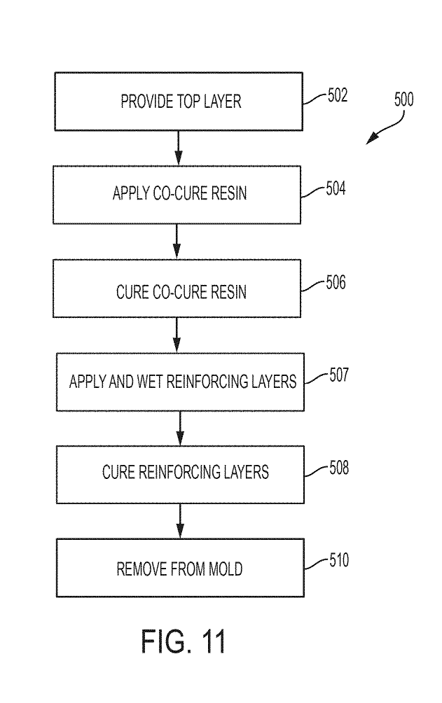

Referring next to FIGS. 5 and 11, the composite floor structure 100 may be formed by a molding process 500.

As shown in block 502, the top layer 210 is provided. The top layer 210 is illustratively a metal layer, such as aluminum or stainless steel. In one exemplary embodiment, a lower surface 213 of the top layer opposite the upper surface 212 is pretreated. Illustrative methods of pretreating lower surface 213 include roughening the lower surface 213, such as by sanding lower surface 213, and cleaning the lower surface 213 with an organic solvent, such as acetone. In one exemplary embodiment, lower surface 213 is pretreated by cleaning the lower surface 213 with an organic solvent, such as acetone, roughening the lower surface 213, such as by sanding, and again cleaning the lower surface 213 with an organic solvent, such as acetone.

As shown in block 504, a co-cure adhesive, such as co-cure adhesive 205 (FIG. 6A) is applied to lower surface 213. In block 506, co-cure adhesive 205 is allowed to at least partially cure. Exemplary curing methods include allowing the co-cure adhesive to air-cure at room temperature, as well as accelerated curing methods such as heat curing, light curing, UV curing, and other suitable methods. In one exemplary embodiment, a single layer of co-cure adhesive 205 is applied to and cured on lower surface 213, as illustrated in FIG. 6A. In another exemplary embodiment, multiple layers of co-cure adhesive 205A, 205B are sequentially applied, as illustrated in FIG. 6B.

In another exemplary embodiment, the co-cure adhesive is not cured prior to application of the reinforcing layers (block 507), and the co-cure adhesive and reinforcing layer are cured together in block 508.

In one exemplary embodiment, the top layer 210 provides a bottom surface to which a support can be attached for forming the rest of composite floor structure 100. Additional support components, such as side components, may be combined with the top layer 210 to form the support structure for the metal top layer 210. As shown in block 508, reinforcing layers, such as reinforcing layers 220, 222, 224, 226, 320, 322, 324, 326, 420, 422, 424, 426, 428, and preforms, such as preforms 310, 410, and 510, are placed in the mold on the at least partially cured co-cure adhesive 205 (FIG. 6A) or 205B (FIG. 6B) to form the rest of composite floor structure 100. The materials are wet with at least one reinforcement resin and a catalyst to impregnate and/or coat the materials into a laminated composite floor structure 100. Advantageously, as shown in the Examples below, the reinforcement resin that is used to form the laminated composite floor structure 100 is also capable of coupling directly to the co-cure adhesive 205 (FIG. 6A) or 205B (FIG. 6B) of the present disclosure. In one exemplary embodiment, the materials are wet with a co-cure adhesive resin as described in Section 1 above. In another exemplary embodiment, the materials are wet with a typical resin. In certain embodiments, a plurality of co-curing resins may be selectively distributed throughout the composite floor structure 100 during the molding process. For example, areas of the composite floor structure 100 that will be susceptible to high stress may receive a resin with a relatively higher polyurethane content, whereas other areas of the composite floor structure 100 that provide bulk and section modulus may receive a lower cost rigid, polyester-based resin, such as an isophthalic polyester resin.

As shown in block 508, the resin and catalyst are cured to form the composite floor structure 100, which is removed from the mold in block 510.

In another embodiment, individual pieces of the composite floor structure 100 may be molded and then coupled together using structural adhesive and/or mechanical fasteners (e.g., bolts, rivets), for example.

In one exemplary embodiment, the method 500 further includes coating the upper surface 212 of metal top layer 210. In a more particular embodiment, the upper surface 212 is pre-coated prior to application of the reinforcing layers in block 507. In another more particular embodiment, the upper surface 212 is post-coated after application of the reinforcing layers in block 507. In some exemplary embodiments, the coating is a co-cure adhesive resin as described in Section 1 above.

The non-metallic areas of composite floor structure 100, such as transverse beams 300 and longitudinal beams 400 of composite floor structure 100, may also be coated. In one embodiment, the non-metallic areas are coated with a co-cure adhesive resin as described in Section 1 above. The urethane content of the co-cure adhesive resin may vary depending on whether the resin is used to coat a metallic surface or a non-metallic surface. In another embodiment, the non-metallic areas are coated with a traditional gel coat.

When composite floor structure 100 is part of a cargo vehicle, for example, a similar method may be performed using similar materials to construct other elements of the cargo vehicle, such as the nose, sidewalls, and/or roof

Additional information regarding the construction of the composite floor structure 100 is disclosed in the following patents and published patent applications, each of which is incorporated by reference in its entirety herein: U.S. Pat. Nos. 5,429,066; 5,664,518; 5,800,749; 5,830,308; 5,897,818; 5,908,591; 6,004,492; 6,013,213; 6,206,669; 6,496,190; 6,497,190; 6,543,469; 6,723,273; 6,755,998; 6,869,561; 6,911,252; and 8,474,871 and U.S. Patent Application Publication Nos. 2014/0199551 and 2014/0262011.

### EXAMPLES

### 1. Four-Point Bend Testing

Composite samples of aluminum with a reinforced floor laminate were prepared and tested consistent with ASTM D790, Standard Test Methods for Flexural Properties of Unreinforced and Reinforced Plastics and Electrical Insulating Materials.

Aluminum plate (0.063 inch thickness) was bonded to a fiber-reinforced laminate using an adhesive as shown in Table 1 below.

Comparative Example A was a vinyl ester resin, available under the 8100 Series CoREZYN® trade name available from Interplastic Corporation, St. Paul, Minn. Comparative Example B was an acrylic adhesive, available under the LORD Maxlok™ MX/T18 Acrylic Adhesive trade name available from LORD Corporation, Cary, N.C. Example 1 was a co-cure adhesive resin including 20 wt. % urethane. The average flexural strength, flexural modulus, and maximum load for six samples of each type of adhesive are shown in Table 1.

TABLE 1
Four-Point Bend Testing

| | | | Flex. | Flex. | |
|---|---|---|---|---|---|
| | Width | Thickness | strength | modulus | Max. load |
| Adhesive | (in) | (in) | (psi) | (psi) | (lb) |
| Comp Ex A | 0.984 | 0.189 | 30,109 | 6.146 × 10⁶ | 99.167 |
| Comp Ex B | 1.023 | 0.216 | 16,806 | 3.283 × 10⁶ | 73.800 |
| Example 1 | 0.985 | 0.215 | 26,305 | 5.152 × 10⁶ | 111.500 |

As shown in Table 1, the samples formed from the co-cure adhesive resin (Example 1) had a higher maximum load than that for either the vinyl ester rein (Comparable Example A) or the acrylic adhesive (Comparable Example B). In addition, the samples formed from the co-cure adhesive resin (Example 1) had relatively high flexular strength and modulus compared to the samples formed from the acrylic adhesive.

The samples formed from the vinyl ester rein (Comparable Example A) and the acrylic adhesive (Comparable Example B) each failed by delamination of the aluminum plate from the fiber-reinforced laminate, indicating that the bond to the co-cure adhesive resin (Example 1) was the point of failure. In contrast, the samples formed from co-cure adhesive resin (Example 1) did not delaminate from the aluminum plate, but rather failed in the fibers of the fiber-reinforced laminate itself, indicating that the bond to the co-cure adhesive resin was stronger than the fiber-reinforced laminate itself

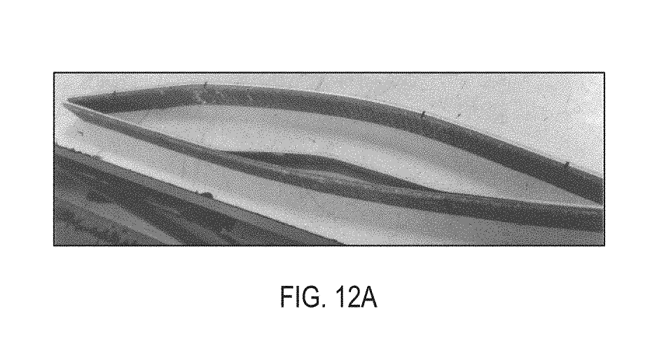

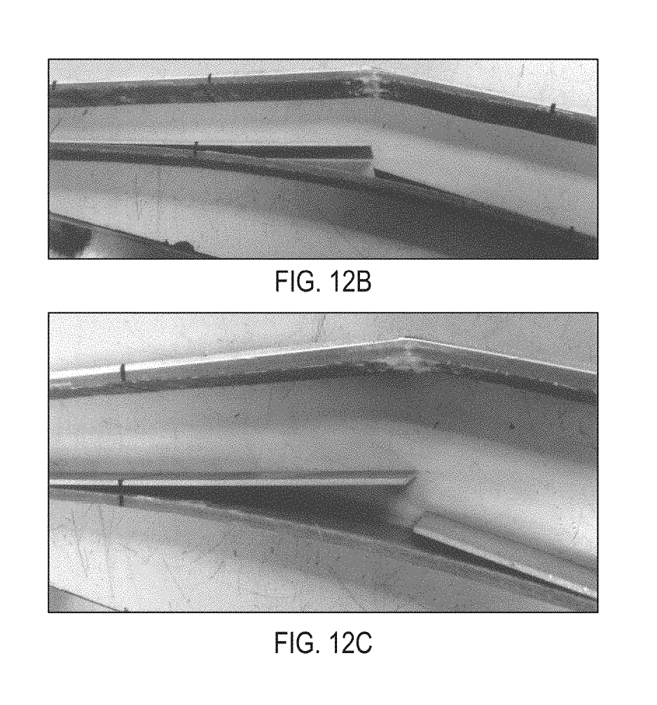

Exemplary samples following testing are shown in FIG. 12A. The upper sample is formed from the co-cure adhesive resin (Example 1), and shows no sign of delamination. Rather, the co-cure adhesive resin and fabric-reinforced laminate have taken the shape of the deformed aluminum plate. In contrast, the lower sample is formed from a typical acrylic adhesive (Comparable Example B), and the aluminum plate has delaminated from the fabric-reinforced laminate.

The exemplary samples shown in FIG. 12B are similar to those in 12A, except that the aluminum plate includes a seam. FIG. 12C is an enlarged view of the samples of FIG. 12B. The upper sample is formed from the co-cure adhesive resin (Example 1), and shows no sign of delamination, even at the seam. Rather, failure was occurred in the fibers of the fiber-reinforced laminate. In contrast, the lower sample is formed from a typical acrylic adhesive (Comparable Example B), and the aluminum plate has delaminated from the fabric-reinforced laminate at the seam location.

### 2. Simulated Floor Surface—Static Testing

A simulated floor surface similar to FIG. 3 having three transverse beams 300 and a 0.0625 inch aluminum sheet as the top layer were prepared using the adhesives of Example 1 above. In addition, similar samples were prepared with Comparative Example C, an acrylic adhesive, available under the LORD Maxlok™ MX/T6 Acrylic Adhesive trade name available from LORD Corporation, Cary, N.C.

Static test to failure was tested by applying a load to the simulated floor surface using a fork truck wheel simulator. The maximum load, the maximum deflection, and the failure mode are provided in Table 2.

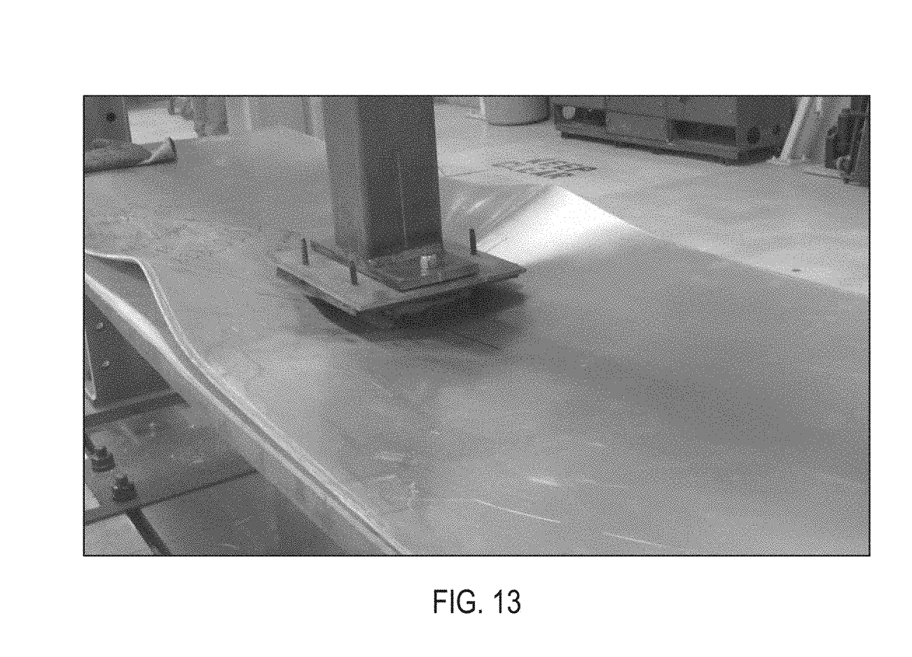

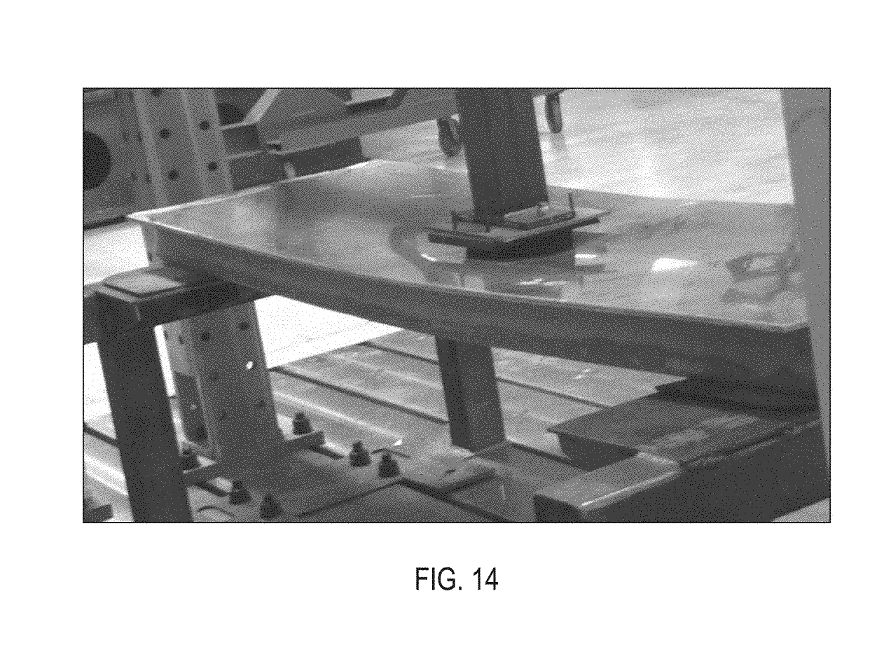

A three-point bend test was performed by applying a load to the center of a 61.5 inch simply supported span until failure occurred. The maximum load, the maximum deflection, and the failure mode are provided in Table 2. FIG. 13 shows the results of the three-point bend test for the acrylic adhesive (Comparative Example C). FIG. 14 shows the results of the three-point bend test for the co-cure adhesive resin (Example 1).

Fork lift wheel crush testing was conducted by constraining the simulated floor surface sample against a solid surface and applying a load using a fork truck wheel simulator directly above a floor crossmember wall until failure occurred (FT @ WEB). The test was then repeated above the center of an undamaged floor crossmember (FT @ CTR).

Pallet jack wheel crush testing was conducted by constraining the simulated floor surface sample against a solid surface and applying a load using a pallet jack wheel simulator directly above a floor crossmember wall until failure occurred (PJ @ WEB). The test was then repeated above the center of an undamaged floor crossmember (PJ @ CTR).

TABLE 2
Static Testing of Simulated Floor Surface

| | FT @ | | FT @ | | PJ @ | | PJ @ | |
|---|---|---|---|---|---|---|---|---|
| | CTR | Deflection | WEB | Deflection | CTR | Deflection | WEB | Deflection |
| Adhesive | (lb) | (in) | (lb) | (in) | (lb) | (in) | (lb) | (in) |
| Example 1 | 22,500 | 0.92 | 20,000 | 0.86 | 17,500 | 1.68 | 17,500 | 0.95 |
| Example 1 | 19,500 | 1.06 | 20,500 | 1.30 | 17,000 | 0.96 | 14,500 | 0.80 |
| Comp | 15,500 | 0.81 | 15,000 | 0.83 | 7,000 | 0.64 | 9,000 | 0.61 |
| Ex C | | | | | | | | |

As shown in Table 2, the samples formed with the co-cure adhesive resin (Example 1) had higher loads and deflection at failure than the acrylic adhesive (Comparative Example C). In addition, the samples formed from the acrylic adhesive (Comparative Example C) delaminated between the aluminum plate and the fabric-reinforced laminate, such as shown in FIG. 13, while samples formed from the co-cure adhesive resin (Example 1) had no delamination during testing, such as shown in FIG. 14.

### 3. Simulated Floor Surface—Dynamic Testing

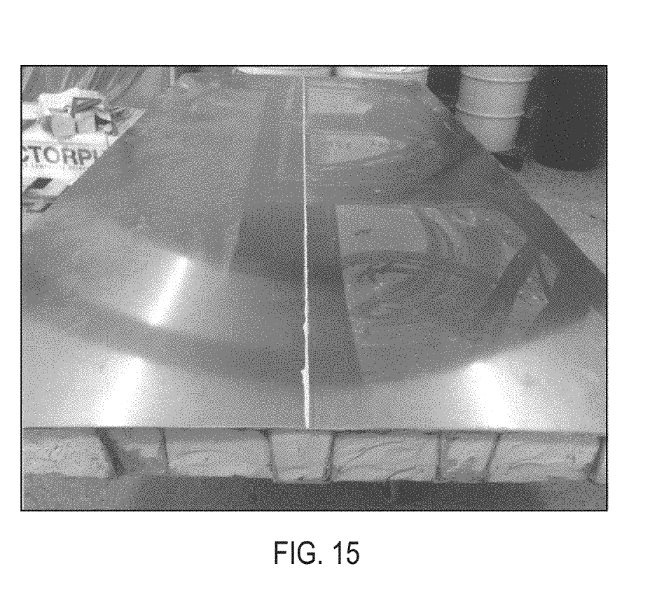

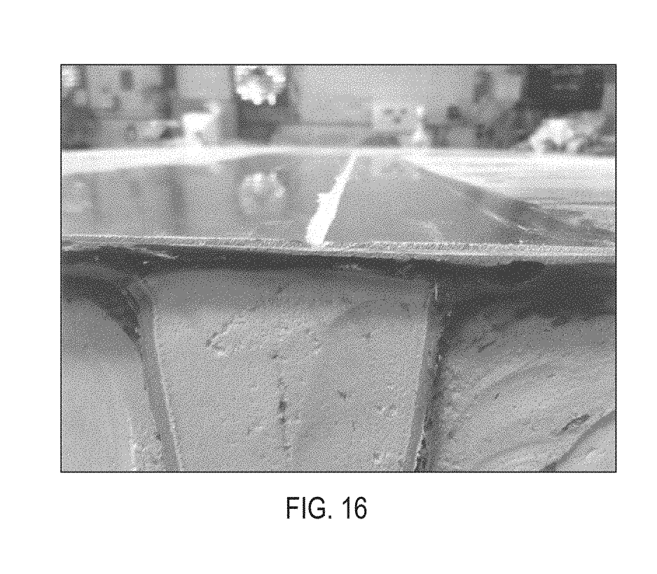

A simulated floor surface similar to FIG. 3 having five transverse beams 300 and an aluminum sheet as the top layer were prepared using the adhesives of Example 1 above. In addition, similar samples were prepared with Comparative Example C, an acrylic adhesive, available under the LORD Maxlok™ MX/T6 Acrylic Adhesive trade name available from LORD Corporation, Cary, N.C. Exemplary pictures of the simulated floor surface are provided in FIGS. 15 and 16.

Testing was conducted similarly to TTMA RP 37, Rating of Van Trailer and Container Floors for Lift Truck Loading by the Truck Trailer Manufacturers Association. A 11,000 to 22,000 pound load was applied using a fork truck axle to the simulated floor surface every 1.5 to 2 seconds. The samples were tested for 100,000 cycles.

The co-cure adhesive resin provided superior results in dynamic adhesion between the aluminum sheet and the laminated layers of fabric-reinforced plastic. The samples formed from the co-cure adhesive resin (Example 1) had no delamination during the dynamic testing. In contrast, the samples formed from the acrylic adhesive (Comparative Example C) delaminated between the aluminum plate and the fabric-reinforced laminate.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

What is claimed is:

1. A composite structure comprising:
a fiber-reinforced plastic;
a metal; and
a co-cure adhesive bonding the fiber-reinforced plastic and the metal, wherein the adhesive comprises at least one resin selected from a vinyl ester resin, a polyester resin, and an epoxy resin and at least one elastomer.

2. The composite structure of claim 1, wherein the fiber-reinforced plastic is a laminate structure.

3. The composite structure of claim 1, wherein the composite structure is a composite floor structure for a cargo vehicle.

4. The composite structure of claim 1, wherein the fiber-reinforced plastic comprises a fiber-wrapped foam core.

5. The composite structure of claim 1, wherein the fiber-reinforced plastic comprises a composite preform

6. The composite structure of 1, wherein the elastomer is urethane.

7. The composite structure of 6, wherein the elastomer comprises from 5 wt. % to 95 wt. %, of the total weight of the co-cure adhesive.

8. The composite structure of 6, wherein the elastomer comprises from 10 wt. % to 25 wt. % of the total weight of the co-cure adhesive.

9. The composite structure of 6, wherein the elastomer comprises from 50 wt. % to 95 wt. % of the total weight of the co-cure adhesive.

10. A composite floor structure comprising:
a platform having an upper metal surface, a plurality of fabric-reinforced plastic layers, and a co-cure adhesive bonding the metal surface and at least one of the fiber-reinforced plastic layers, wherein the adhesive comprises at least one resin selected from a vinyl ester resin, a polyester resin, and an epoxy resin and at least one elastomer.

11. The composite floor structure of 10, further comprising a plurality of transverse beams integrally molded to the platform.

12. The composite floor structure of claim 11, wherein each transverse beam includes:
a preform;
a first reinforcing layer sized to wrap around the preform; and
a second reinforcing layer sized smaller than the first reinforcing layer for selective positioning beneath the preform.

13. A method of bonding a fiber-reinforced plastic to a metal, the method comprising:
applying an adhesive to a surface of the metal to form a co-cure layer wherein the adhesive is a co-cure adhesive comprising at least one resin selected from a vinyl ester resin, a polyester resin, and an epoxy resin and at least one elastomer;
contacting the co-cure layer with a reinforcing layer and a reinforcement resin;
curing the reinforcement resin to form a fiber-reinforced plastic, wherein the fiber-reinforced plastic is bonded to the metal by the co-cure layer.

14. The method of claim 13, wherein the adhesive is at least partially cured prior to application of the reinforcing layer.

15. The method of claim 13, wherein curing the reinforcement resin further comprises curing the co-cure adhesive of the co-cure layer.

16. The method of claim 13, wherein the reinforcement resin is a co-cure adhesive comprising at least one resin selected from a vinyl ester resin, a polyester resin, and an epoxy resin and at least one elastomer, and wherein curing the reinforcement resin further comprises curing the co-cure adhesive of the co-cure layer.

17. The method of claim 13, further comprising pretreating the surface of the metal with an organic solvent prior to applying the adhesive.

18. The method of claim 13, further comprising pretreating the surface of the metal by roughening the surface.

19. The method of claim 13, wherein the reinforcement resin is bonded directly to the co-cure layer.

20. The method of claim 13, wherein the surface of the metal forms a portion of a mold into which the reinforcing layer and the reinforcement resin are applied.

21. The method of claim 13, wherein contacting the co-cure layer with the reinforcing layer and the reinforcement resin further includes contacting the co-cure layer with a catalyst.

22. The method of claim 13, wherein the method further includes coating a second surface of the metal with a co-cure adhesive resin comprising at least one resin selected from a vinyl ester resin, a polyester resin, and an epoxy resin and at least one elastomer, wherein the second surface is opposite the surface to which the adhesive is applied.

23. The method of claim 22, wherein the coating step is performed prior to the contacting step.

24. The method of claim 22, wherein the coating step is performed after the contacting step.

25. The method of claim 22, further comprising coating the fiber-reinforced plastic with a resin different from the co-cure adhesive resin used to coat the second surface of the metal.

26. The method of claim 25, wherein the resin used to coat the fiber-reinforced plastic has a different urethane content than the co-cure adhesive resin used to coat the second surface of the metal.

27. The method of claim 13, further comprising forming the metal, the fiber-reinforced plastic, and the cured co-cure layer into a desired shape by applying a force to deform the metal.
